(19) United States
(12) Patent Application Publication
(10) Pub. No.: US 2017/0310846 A1
(43) Pub. Date: Oct. 26, 2017

(54) TRANSMIT DESTINATION CHANGING APPARATUS, PRINTING SYSTEM, AND NON-TRANSITORY COMPUTER READABLE MEDIUM

(71) Applicant: FUJI XEROX CO., LTD., Tokyo (JP)

(72) Inventors: Ryoko SAITOH, Kanagawa (JP); Yuichi KAWATA, Kanagawa (JP); Hideki YAMASAKI, Kanagawa (JP); Yoshifumi BANDO, Kanagawa (JP); Kensuke OKAMOTO, Kanagawa (JP); Tomoyo NISHIDA, Kanagawa (JP)

(73) Assignee: FUJI XEROX CO., LTD., Tokyo (JP)

(21) Appl. No.: 15/357,411

(22) Filed: Nov. 21, 2016

(30) Foreign Application Priority Data
Apr. 26, 2016 (JP) 2016-087900

(51) Int. Cl. H04N 1/32; H04N 1/00

(52) U.S. Cl. CPC H04N 1/32496; H04N 1/32523; H04N 1/00832; H04N 2201/3202; H04N 2201/3207; H04N 2201/0094

(57) ABSTRACT

A transmit destination changing apparatus includes an acquiring unit that acquires track record information, the track record information indicating a track record of printing of print data transmitted from a print data transmitting apparatus to a first printer among multiple printers, the track record information indicating a track record of printing performed on each of the plural printers in response to a print request, and an output unit that outputs change instruction information if the track record information indicates that print data transmitted to the first printer from the print data transmitting apparatus is likely to be printed on a second printer among the multiple printers in response to a print request, the change instruction information instructing that the destination of the print data be changed to cause the print data to be transmitted to the second printer from the print data transmitting apparatus.

### CROSS-REFERENCE TO RELATED APPLICATIONS

This application is based on and claims priority under 35 USC 119 from Japanese Patent Application No. 2016-087900 filed Apr. 26, 2016.

### BACKGROUND

The present invention relates to a transmit destination changing apparatus, a printing system, and a non-transitory computer readable medium.

### SUMMARY

According to an aspect of the invention, there is provided a transmit destination changing apparatus including an acquiring unit, and an output unit. The acquiring unit acquires track record information. The track record information indicates a track record of printing of print data transmitted from a print data transmitting apparatus to a first printer among multiple printers, and indicates a track record of printing performed on each of the multiple printers in response to a print request. The output unit outputs change instruction information if the track record information indicates that print data transmitted to the first printer from the print data transmitting apparatus is likely to be printed on a second printer among the multiple printers in response to a print request. The change instruction information instructs that the destination of the print data be changed to cause the print data to be transmitted to the second printer from the print data transmitting apparatus.

### BRIEF DESCRIPTION OF THE DRAWINGS

Exemplary embodiment of the present invention will be described in detail based on the following figures, wherein:

FIG. 1 illustrates a general configuration of a printing system according to an exemplary embodiment of the present invention;

FIG. 2 illustrates a hardware configuration of a printer according to the exemplary embodiment of the present invention;

FIG. 3 is a block diagram illustrating a functional configuration of a management information processor within a printer according to the exemplary embodiment of the present invention;

FIG. 4 illustrates a specific example of management information stored in a management information memory within a management information processor according to the exemplary embodiment of the present invention;

FIG. 5 is a flowchart illustrating operation of a management information processor within a host printer according to the exemplary embodiment of the present invention; and

FIG. 6 is a flowchart illustrating operation of a management information processor within a non-host printer according to the exemplary embodiment of the present invention.

### DETAILED DESCRIPTION

Hereinafter, an exemplary embodiment of the present invention will be described in detail with reference to the attached drawings.

### General Configuration of Printing System

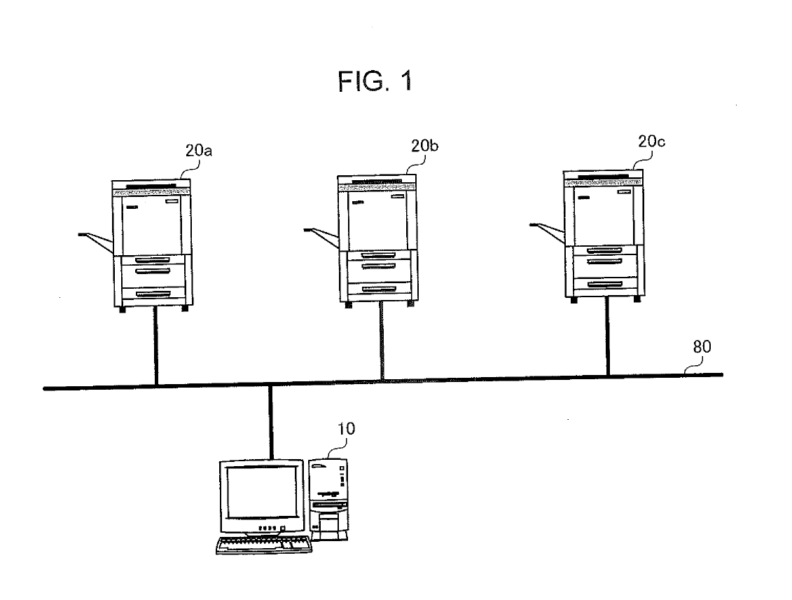

FIG. 1 illustrates a general configuration of a printing system according to the exemplary embodiment. As illustrated in FIG. 1, the printing system includes a terminal apparatus 10, and printers 20a, 20b, and 20c. The terminal apparatus 10 and the printers 20a, 20b, and 20c are connected by a communication line 80. Although only one terminal apparatus 10 is illustrated, the printing system may include two or more terminal apparatuses 10. The printers 20a, 20b, and 20c will be referred to as printer 20 or printers 20 if there is no need to distinguish between these printers. Although three printers 20 are illustrated, the printing system may include four or more printers 20.

The terminal apparatus 10 is a computer apparatus operated by the user to print the data to be printed. In response to a user's operation, the terminal apparatus 10 transmits, to the printer 20, the print data indicated by the user to be printed. Print data in this case is, for example, Page Description Language (PDL) data written in PDL format. The print data includes, in addition to drawing data for drawing the data to be printed, print attributes indicating information such as the number of printed sheets and whether printing is color or monochrome. The terminal apparatus 10 has a transmit destination switching function for switching the printer 20 to which print data is transmitted first. The terminal apparatus 10 used may be, for example, a personal computer (PC). In the exemplary embodiment, the terminal apparatus 10 is provided as an example of a print data transmitting apparatus.

The printer 20 is an apparatus that performs printing by forming an image on a recording medium such as paper. Although the printer 20 used may only have a print function, the printer 20 used may have, in addition to a print function, other image processing functions such as a copy function, a scan function, and a facsimile function.

The communication line 80 is a communication section used for communication of information between the terminal apparatus 10 and the printer 20. As the communication line 80, for example, a local area network (LAN) or the Internet may be used.

### Overview of Exemplary Embodiment

In the exemplary embodiment, one of the printers 20a, 20b, and 20c is set as a host printer. The term “host printer” as used herein refers to the printer 20 to which the terminal apparatus 10 transmits print data first. That is, the terminal apparatus 10 first transmits print data to the host printer, and the transmitted print data is stored in the host printer for a while.

Accordingly, the exemplary embodiment manages which printer 20 has actually printed the print data stored in the host printer in response to a print request. In other words, the exemplary embodiment manages from which printer 20 the user has collected the printed material. Further, the host printer is switched such that the printer 20 with the highest frequency of use, that is, the printer 20 from which the printed material is collected with the highest frequency, becomes a new host printer.

Specifically, the host printer is switched for each individual user in accordance with each of the rules described below.

A first rule specifies that the host printer be set as the printer 20 on which printing has been performed the greatest number of times within a predetermined period of time.

A second rule specifies that the host printer be set as the printer 20 on which printing has been performed the greatest cumulative number of times so far.

A third rule specifies that the host printer be set as the printer 20 with the greatest value of time-weighted number of prints performed on the printer 20. A conceivable example of “time” in this case is the time that has elapsed from the date/time of printing to the current date/time. For example, the weight is increased if the time that has elapsed from the date/time of printing to the current date/time is short, and decreased if the time that has elapsed from the date/time of printing to the current date/time is long. Although a time-weighted value of the number of prints performed is used as an example in this case, this is not to be construed restrictively. Any value that indicates the number of prints performed and the timing of printing performed may be used.

A fourth rule specifies that the correlation between the number of printed sheets and the number of prints performed be determined for each of the printers 20, and the host printer be set as the printer 20 on which printing has been performed the greatest number of times for a given number of printed sheets included in the print data. Although the number of printed sheets is used as an example in this case, this is not to be construed restrictively. The fourth rule may be more generally restated as the following rule: the host printer be set as the printer 20 on which printing has been performed the greatest number of times for a given print attribute included in the print data. Conceivable examples of print attributes include the amount of color toner used.

The following provides an overview of the exemplary embodiment with reference to FIG. 1. It is assumed in this case that of the printers 20a, 20b, and 20c, the printer 20a is the host printer, and the printer 20b is the printer 20 frequently used by User A, who is the user of the terminal apparatus 10. In this case, the printer 20a is an example of a first printer, and the printer 20b is an example of a second printer. Switching of the host printer in the exemplary embodiment is achieved by one of the printers 20a, 20b, and 20c within the printing system retaining information used to manage printing that occurs on the printers 20a, 20b, and 20c (to be referred to as “management information” hereinafter). The following description assumes that the printer 20a serving as a host printer retains the management information.

First, as a first stage, when User A operates the terminal apparatus 10 to request for printing, the terminal apparatus 10 transmits print data to the printer 20a. Thus, the printer 20a stores print data in association with a user ID that identifies User A.

Next, as a second stage, User A moves to the location where the printer 20b is placed, and operates the printer 20b to request for printing of the print data associated with the user ID of User A.

Then, as a third stage, the printer 20b makes an inquiry to the printer 20b itself and the other printers, the printers 20a and 20c, about whether these printers store the print data associated with the user ID of User A.

In this example, the print data associated with the user ID of User A is stored in the printer 20a. Accordingly, as a fourth stage, the printer 20a transfers the print data to the printer 20b.

Thus, as a fifth stage, the printer 20b prints the print data transferred from the printer 20a.

As a sixth stage, the printer 20b transmits, to the printer 20a, management information indicating that the print data transmitted from the terminal apparatus 10 in response to a request from User A has been printed on the printer 20b.

Thereafter, the printer 20a refers to the management information at any given timing. Then, if the printer 20a determines that print data stored in the printer 20a is more likely to be printed on the printer 20b than on the printer 20a, the host printer is changed from the printer 20a to the printer 20b.

### Hardware Configuration of Printer

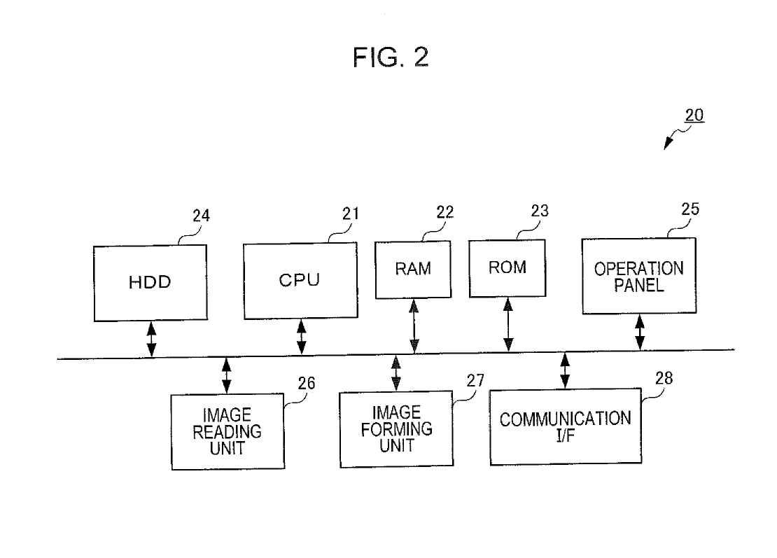

FIG. 2 illustrates a hardware configuration of the printer 20 according to the exemplary embodiment. As illustrated in FIG. 2, the printer 20 includes a central processing unit (CPU) 21, a random access memory (RAM) 22, a read only memory (ROM) 23, a hard disk drive (HDD) 24, an operation panel 25, an image reading unit 26, an image forming unit 27, and a communication interface (to be referred to as “communication I/F” hereinafter) 28.

The CPU 21 loads various programs stored in the ROM 23 or other devices into the RAM 22 and executes the programs to implement various functions described later.

The RAM 22 is a memory used as, for example, a working memory for the CPU 21.

The ROM 23 is a memory that stores, for example, various programs executed by the CPU 21.

The HDD 24 is, for example, a magnetic disk device that stores data, such as image data read by the image reading unit 26, and image data used to form an image in the image forming unit 27.

The operation panel 25 is, for example, a touch panel that displays various information and receives operational inputs from the user. The operation panel 25 includes a display for displaying various information, and a position detection sheet for detecting the position indicated by a finger or a stylus. Alternatively, a display and a keyboard may be used instead of a touch panel.

The image reading unit 26 reads an image recorded on a recording medium such as paper. The image reading unit 26 is, for example, a scanner. The image reading unit 26 used may be of a CCD type in which light is applied to a document from a light source, and the light reflected from the document is condensed by a lens before being received by charge coupled devices (CCDs). Alternatively, the image reading unit 26 used may be of a CIS type in which light is applied sequentially from each of LED light sources, and the reflected light is received by a contact image sensor (CIS).

The image forming unit 27 forms an image on a recording medium. The image forming unit 27 is, for example, a printer. The image forming unit 27 used may employ the electrophotographic system, in which toner deposited on a photoconductor is transferred to a recording medium to form an image on the recording medium, or the ink jet system, in which ink is discharged onto a recording medium to form an image on the recording medium.

The communication I/F 28 transmits and receives various information to and from another device via the communication line 80.

### Functional Configuration of Management Information Processor

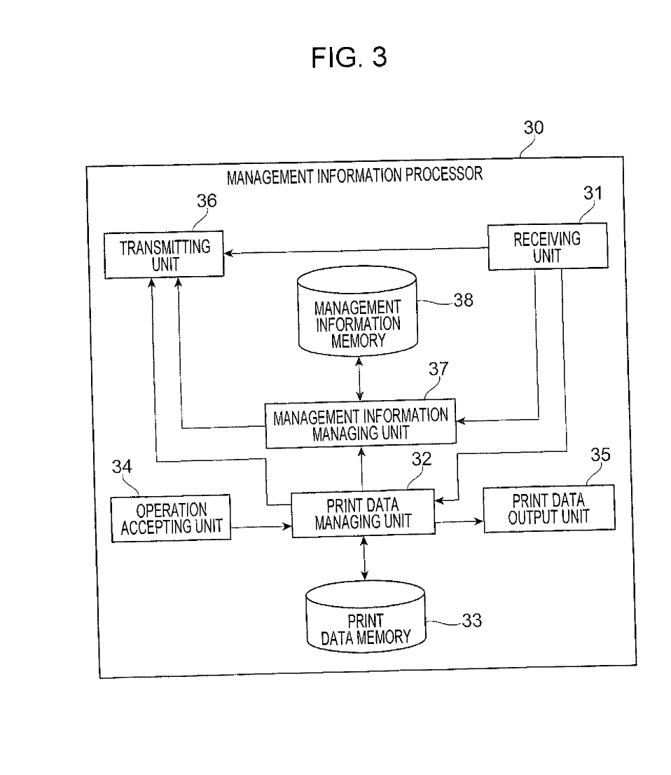

FIG. 3 is a block diagram illustrating an exemplary functional configuration of a management information processor 30 that operates within the printer 20. The management information processor 30 is understood as a unit implemented when the CPU 21 (see FIG. 2) of the printer 20 reads a program used for implementing various functional units described later from the HDD 24 (see FIG. 2) to the RAM 22 (see FIG. 2) and executes the program.

Since the printer 20 may or may not be a host printer, the management information processor 30 includes processing units that are common to both host and non-host printers, and processing units that operate only in the host printer. Specifically, the printer 20 includes the following units as the processing units common to both host and non-host printers: a receiving unit 31, a print data managing unit 32, a print data memory 33, an operation accepting unit 34, a print data output unit 35, and a transmitting unit 36. The printer 20 further includes, as the processing units that operate only in the host printer, a management information managing unit 37, and a management information memory 38. If the printer 20 is a host printer, the management information processor 30 has the function of changing the host printer, and thus the management information processor 30 is an example of a transmit destination changing apparatus.

If the printer 20 is a host printer (to be referred to as “host printer 20” hereinafter), the receiving unit 31 receives print data that is transmitted from the terminal apparatus 10 in accordance with the settings on the host printer. Alternatively, the user may, on the terminal apparatus 10, designate a non-host printer as the destination of print data irrespective of the settings on the host printer, and the terminal apparatus 10 may transmit print data in accordance with this designation. Accordingly, if the printer 20 is a non-host printer, the receiving unit 31 may receive, from the terminal apparatus 10, print data transmitted in accordance with such a designation.

In addition, if the printer 20 is a host printer, the receiving unit 31 receives, from another printer 20, an inquiry as to whether the host printer 20 stores the print data currently being requested to be printed, a transfer request for the print data, and management information. If the printer 20 is a non-host printer (to be referred to as “non-host printer 20” hereinafter), the non-host printer 20 receives, from each of the other printers 20, a reply as to whether the other printers 20 store the print data currently being requested to be printed. Then, the non-host printer 20 receives the print data from another printer 20 that stores the print data currently being requested to be printed. Further, if the printer 20 is a non-host printer, the non-host printer 20 may receive, from another printer 20, an inquiry as to whether the non-host printer 20 stores the print data currently being requested to be printed.

The print data managing unit 32 stores the print data received by the receiving unit 31 from the terminal apparatus 10 into the print data memory 33, irrespective of whether the printer 20 is a host printer or not. If the printer 20 is a host printer, when the operation accepting unit 34 accepts a user's print request, the host printer 20 reads print data from the print data memory 33 and passes the print data to the print data output unit 35. At the same time, the host printer 20 informs the management information managing unit 37 of the fact that the print data has been printed on the host printer 20, and when the receiving unit 31 receives a transfer request for the print data, the host printer 20 reads the print data from the print data memory 33 and passes the print data to the transmitting unit 36. In some cases, even if the printer 20 is a non-host printer, when the operation accepting unit 34 accepts a user's print request, the non-host printer 20 reads print data from the print data memory 33 and passes the print data to the print data output unit 35. However, normally, the non-host printer 20 passes, to the print data output unit 35, the print data received by the receiving unit 31 from another printer 20 that stores the print data currently being requested to be printed.

The print data memory 33 stores print data under control of the print data managing unit 32, irrespective of whether the printer 20 is a host printer or not.

The operation accepting unit 34 accepts a user's print request made on the operation panel 25 (see FIG. 2), irrespective of whether the printer 20 is a host printer or not.

The print data output unit 35 outputs, to the image forming unit 27 (see FIG. 2), the print data passed to the print data output unit 35 from the print data managing unit 32 to thereby control printing on the printer 20, irrespective of whether the printer 20 is a host printer or not.

The transmitting unit 36 transmits, if the printer 20 is a host printer, the print data passed to the transmitting unit 36 from the print data managing unit 32 to another printer 20 that has made an inquiry as to whether the host printer 20 stores the print data currently being requested to be printed. When the transmitting unit 36 receives, from the management information managing unit 37, an indication that the host printer is to be changed, the transmitting unit 36 transmits an instruction to change the settings on the host printer to the terminal apparatus 10. In the exemplary embodiment, the transmitting unit 36 is provided as an example of an output unit that outputs change instruction information that instructs the destination of print data to be changed. If the printer 20 is a non-host printer, the transmitting unit 36 transmits, to the other printers 20, an inquiry as to whether the other printers 20 store the print data currently being requested to be printed. Then, the transmitting unit 36 transmits a transfer request for the print data, and management information to another printer 20 that stores the print data currently being requested to be printed.

The management information managing unit 37 updates management information stored in the management information memory 38, either based on information indicating that the print data has been printed on the host printer 20 that is transmitted from the print data managing unit 32, or based on management information received by the receiving unit 31 from another printer 20. Further, the management information managing unit 37 checks management information at any given timing to determine whether to change the host printer, and informs the transmitting unit 36 of the result of the determination. At this time, the determination of whether to change the host printer may be made by determining whether each of the following items of information satisfies its corresponding condition: the number of prints performed within a predetermined period of time, the cumulative number of prints performed so far, the time-weighted value of the number of prints performed, and the number of prints performed for a given number of printed sheets included in the print data. In the exemplary embodiment, each item of information mentioned above is used as an example of track record information, which is information indicating a track record of printing of print data transmitted from the print data transmitting apparatus to the first printer and indicating a track record of printing that has been performed on each printer in response to a print request. Further, the management information managing unit 37 is provided as an example of an acquiring unit that acquires the track record information. Further, if each item of information mentioned above satisfies its corresponding condition, this represents an example of when the track record information indicates that print data transmitted to the first printer from the print data transmitting apparatus is likely to be printed on the second printer in response to a print request.

The management information memory 38 stores management information under control of the management information managing unit 37.

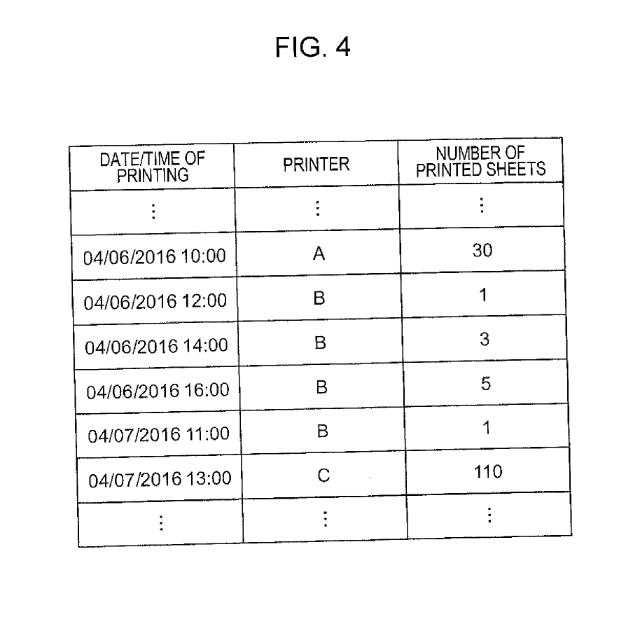

FIG. 4 illustrates a specific example of management information stored in the management information memory 38. The exemplary embodiment assumes that such management information is stored for each individual terminal apparatus 10. As illustrated in FIG. 4, each record of management information includes the following items of information: Date/Time of Printing, Printer, and Number of Printed Sheets. Information set as Date/Time of Printing is the date/time when a print managed by each record is performed. Information set as Printer is the device ID used to identify the printer 20 on which a print managed by each record is performed. In this example, the device IDs of the printers 20a, 20b, and 20c are respectively designated A, B, and C. Further, information set as Number of Printed Sheets is the number of sheets of the recording medium on which a print managed by each record is performed.

One way to manage management information would be to delete an item of information if a predetermined period of time has elapsed from the time of recording of the item of information. However, since the following description is also directed to cases in which the host printer is determined in accordance with the second rule mentioned above or other rules, it is assumed in the present case that once recorded, all items of information are left without being deleted.

### Operation of Management Information Processor

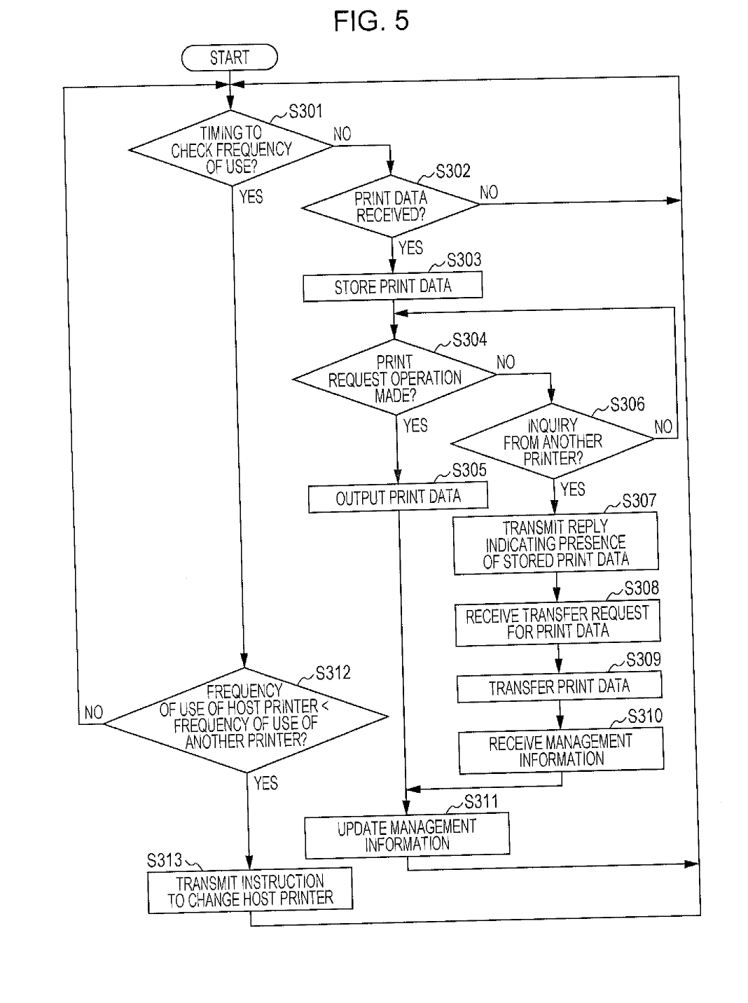

FIG. 5 is a flowchart illustrating an example of operation of the management information processor 30 within the printer 20 that is a host printer. This operation starts upon activation of the printer 20 that is a host printer, and continues until the printer 20 ceases to be a host printer.

When the operation starts, the management information managing unit 37 of the management information processor 30 determines whether it is currently the timing to check the frequency of use (step 301).

First, the following describes a case in which the management information managing unit 37 determines that it is currently not the timing to check the frequency of use. In this case, it is determined whether the receiving unit 31 has received print data from the terminal apparatus 10 (step 302). If it is determined that the receiving unit 31 has not received print data from the terminal apparatus 10, the processing returns to step 301. If it is determined that the receiving unit 31 has received print data from the terminal apparatus 10, the print data managing unit 32 stores the received print data into the print data memory 33 (step 303).

Next, it is determined whether the operation accepting unit 34 has accepted a user's print request operation made on the operation panel 25 (see FIG. 2) (step 304).

At this time, if it is determined that the operation accepting unit 34 has accepted such a print request operation, the management information processor 30 outputs, to the image forming unit 27 (see FIG. 2), the print data currently being requested to be printed (step 305). Specifically, the print data managing unit 32 reads the print data from the print data memory 33 and passes the read print data to the print data output unit 35. Then, the print data output unit 35 outputs the print data passed to the print data output unit 35 to the image forming unit 27 (see FIG. 2). Then, the print data managing unit 32 informs the management information managing unit 37 of the fact that the print data has been printed on the host printer 20. Then, the management information managing unit 37 updates management information stored in the management information memory 38 by adding, to the management information, information indicating that the print data has been printed on the host printer 20 (step 311).

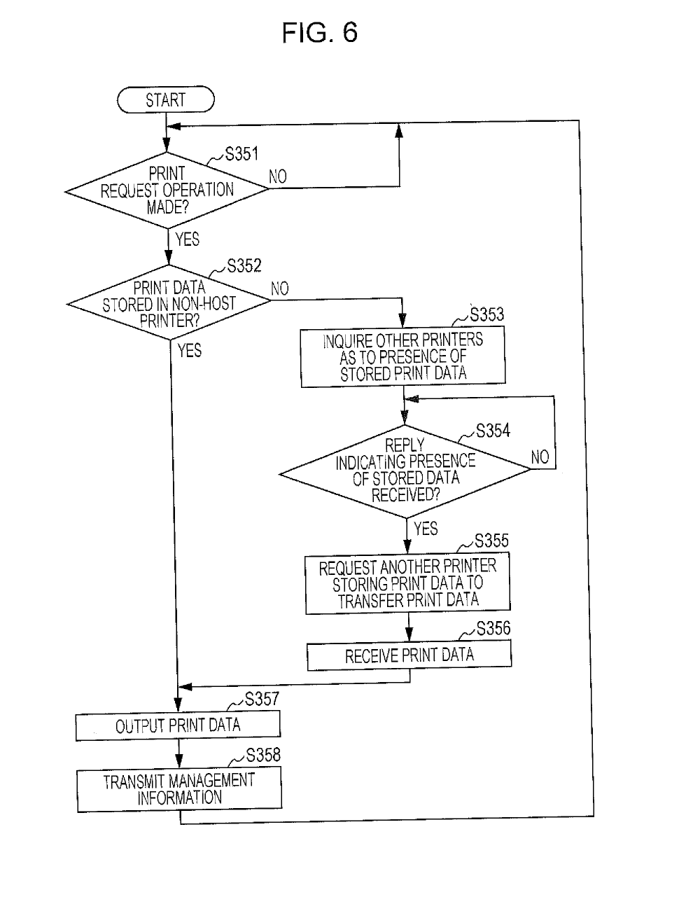

If it is determined that the operation accepting unit 34 has not accepted such a print request operation, it is determined whether the receiving unit 31 has received, from another printer 20, an inquiry as to whether the host printer 20 stores the print data currently being requested to be printed (step 306). If it is determined that the receiving unit 31 has not received such an inquiry, the processing returns to step 304. If it is determined that the receiving unit 31 has received such an inquiry, the transmitting unit 36 transmits a reply that the print data currently being requested to be printed is stored in the host printer 20 (step 307). As a result, a transfer request for the print data is transmitted from the printer 20 that has originated the inquiry (to be referred to as “inquiry-originating printer 20” hereinafter), and then the receiving unit 31 receives this transfer request (step 308). Then, the management information processor 30 transmits the print data to the inquiry-originating printer 20 (step 309). Specifically, the print data managing unit 32 reads the print data from the print data memory 33 and passes the read print data to the transmitting unit 36. Then, the transmitting unit 36 transmits the print data passed to the transmitting unit 36 to the inquiry-originating printer 20. As a result, the operation illustrated in FIG. 6 described later is performed. Then, management information indicating that the print data has been printed on the inquiry-originating printer 20 is transmitted from the inquiry-originating printer 20, and this management information is received by the receiving unit 31 (step 310). Thereafter, the management information indicating that the print data has been printed on the inquiry-originating printer 20 is sent from the receiving unit 31 to the management information managing unit 37. Then, the management information managing unit 37 updates management information stored in the management information memory 38 by adding, to this management information, the management information sent from the receiving unit 31 (step 311).

Next, the following describes a case in which the management information managing unit 37 determines at step 301 that it is currently the timing to check the frequency of use. In this case, the management information managing unit 37 determines whether the printer 20 that is a non-host printer (another printer) has been used more frequently than the host printer (step 312). Now, how this determination is specifically made will be described with the management information illustrated in FIG. 4 as an example.

First, if the first rule mentioned above is to be used, multiple records each including a date/time that falls within a predetermined period of time are extracted from all of the records of the management information illustrated in FIG. 4. Further, these records are divided into multiple groups based on which printer 20 is included in each record. Then, for each of the groups, the number of records within the group is determined. Then, the printer 20 corresponding to the group with the greatest number of records is determined to be a host printer. In the example illustrated in FIG. 4, assuming that printing has been performed only six times within a predetermined period of time as illustrated in FIG. 4, the printer 20b is determined to be a host printer.

Next, if the second rule mentioned above is to be used, all of the records of the management information illustrated in FIG. 4 are divided into multiple groups based on which printer 20 is included in each record. Then, for each of the groups, the number of records within the group is determined. Then, the printer 20 corresponding to the group with the greatest number of records is determined to be a host printer.

Next, if the third rule mentioned above is to be used, each of the records of the management information illustrated in FIG. 4 is associated with a weight according to the time that has elapsed from the date/time of printing included in the record to the current date/time. Further, all of the records are divided into multiple groups based on which printer 20 is included in each record. Then, for each of the groups, the sum total of weights associated with the records included in the group is determined. Then, the printer 20 corresponding to the group with the greatest sum total of weights is determined to be a host printer.

Next, if the fourth rule mentioned above is to be used, each of the records of the management information illustrated in FIG. 4 is associated with a sheet count range including the number of printed sheets included in the record. For example, if the number of printed sheets is in the range of 1 to 10, “Low” is associated with the corresponding record as a sheet count range. If the number of printed sheets is in the range of 11 to 100, “Medium” is associated with the corresponding record as a sheet count range. If the number of printed sheets is equal to or more than 101, “High” is associated with the corresponding record as a sheet count range. Further, all of the records are divided into multiple groups based on which sheet count range is associated with each group and which printer 20 is included in each record. Then, for each of the groups, the number of records within the group is determined. Then, for each sheet count range, the printer 20 corresponding to the group with the greatest number of records is determined to be the printer 20 that acts as a host printer when a number of sheets within the sheet count range are to be printed. In the example illustrated in FIG. 4, provided that the printing under consideration is only the six printing events illustrated in FIG. 4, the printer 20a is determined to be the host printer for printing of a number of sheets ranging from 1 to 10, the printer 20b is determined to be the host printer for printing of a number of sheets ranging from 11 to 100, and the printer 20c is determined to be the host printer for printing of a number of sheets equal to or greater than 101.

If it is determined at step 312 that another printer is not used more frequently than the host printer, there is no need to change the host printer, and thus the processing returns to step 301. If it is determined that another printer is used more frequently than the host printer, the management information managing unit 37 informs the transmitting unit 36 to that effect, and the transmitting unit 36 transmits, to the terminal apparatus 10, an instruction to change the host printer (step 313).

FIG. 6 is a flowchart illustrating an example of operation of the management information processor 30 within the printer 20 that is a non-host printer. This operation starts upon activation of the printer 20 that is a non-host printer, and continues until the printer 20 becomes a host printer.

When the operation starts, the management information processor 30 determines whether the operation accepting unit 34 has accepted a user's print request operation made on the operation panel 25 (see FIG. 2) (step 351). If it is determined that the operation accepting unit 34 has not accepted such a print request operation, the processing returns to step 351. If it is determined that the operation accepting unit 34 has accepted such a print request operation, the print data managing unit 32 determines whether the print data currently being requested to be printed is stored in the print data memory 33 (step 352).

At this time, if it determined that the print data currently being requested to be printed is stored in the print data memory 33, the management information processor 30 outputs, to the image forming unit 27 (see FIG. 2), the print data currently being requested to be printed (step 357). Specifically, the print data managing unit 32 reads the print data from the print data memory 33 and passes the read print data to the print data output unit 35. Then, the print data output unit 35 outputs the print data passed to the print data output unit 35 to the image forming unit 27 (see FIG. 2). Then, information indicating that the print data has been printed on the non-host printer 20 is sent from the print data managing unit 32 to the transmitting unit 36. Then, the transmitting unit 36 transmits, to the host printer, management information indicating that the print data has been printed on the non-host printer 20 (step 358).

If it determined that the print data currently being requested to be printed is not stored in the print data memory 33, the transmitting unit 36 transmits, to other printers 20, an inquiry as to whether the other printers 20 store the print data currently being requested to be printed (step 353). Then, it is determined whether the receiving unit 31 has received, from any one of the printers 20, a reply that the printer 20 stores the print data currently being requested to be printed (step 354). If it is determined that the receiving unit 31 has not received, from any one of the printers 20, a reply that the printer 20 stores the print data currently being requested to be printed, the processing returns to step 354. If it is determined that the receiving unit 31 has received, from any one of the printers 20, a reply that the printer 20 stores the print data currently being requested to be printed, the transmitting unit 36 requests the printer 20 that has transmitted such a reply to transfer the print data (step 355). As a result, the print data is transmitted from the printer 20 that is being requested to transfer the print data, and the receiving unit 31 receives the transmitted print data (step 356). Then, the management information processor 30 outputs the print data to the image forming unit 27 (see FIG. 2) (step 357). Specifically, the print data managing unit 32 passes the print data received by the receiving unit 31 to the print data output unit 35. Then, the print data output unit 35 outputs the print data passed to the print data output unit 35 to the image forming unit (see FIG. 2). Then, information indicating that the print data has been printed on the non-host printer 20 is sent from the print data managing unit 32 to the transmitting unit 36. Then, the transmitting unit 36 transmits, to the host printer 20, management information indicating that the print data has been printed on the non-host printer 20 (step 358).

In some cases, the printer 20 that is a non-host printer also receives print data from the terminal apparatus 10 as described above. Further, in some cases, the non-host printer 20 receives, from another printer 20, an inquiry as to whether the print data currently being requested to be printed is stored in the non-host printer 20 and, in response to this inquiry, transmits a reply that the print data is not stored in the non-host printer 20. However, such an operation is not illustrated in FIG. 6.

Although management information is retained by the host printer in the exemplary embodiment, this is not to be construed restrictively. For example, management information may be retained by the printer 20 that is a non-host printer. Alternatively, management information may be retained not by the printer 20 but by each individual terminal apparatus 10. In this case, each terminal apparatus 10 receives management information from the printer 20 that has actually printed the print data, and switches the host printer based on the received management information.

Further, although the foregoing description of the exemplary embodiment assumes that a single terminal apparatus 10 is used by a single user, it may be assumed that a single terminal apparatus 10 is shared by multiple users. In that case, the following configuration may be employed. The management information illustrated in FIG. 4 is stored for each individual terminal apparatus 10 and for individual each user. When a user attempts to use the terminal apparatus 10, user authentication is performed, and the management information stored for the corresponding terminal apparatus 10 and for the authenticated user is used to determine the host printer.

Furthermore, although the printer 20 that is a host printer instructs the terminal apparatus 10 to switch the host printer in the exemplary embodiment, this is not to be construed restrictively. A dedicated server computer separate from the printer 20 may instruct the terminal apparatus 10 to switch the host printer. In that case, the dedicated server computer may retain, in addition to the management information illustrated in FIG. 4, information on the settings of the host printer used when each print is performed.

### Program

The processing executed by the management information processor 30 according to the exemplary embodiment is provided as a program, for example, application software.

That is, a program that implements the exemplary embodiment may be understood as a program for causing a computer to implement functions including: acquiring track record information, the track record information indicating a track record of printing of print data transmitted from a print data transmitting apparatus to a first printer among multiple printers, the track record information indicating a track record of printing performed on each of the multiple printers in response to a print request, and outputting change instruction information if the track record information indicates that print data transmitted to the first printer from the print data transmitting apparatus is likely to be printed on a second printer among the multiple printers in response to a print request, the change instruction information instructing that the destination of the print data be changed to cause the print data to be transmitted to the second printer from the print data transmitting apparatus.

In addition to being provided via a communication section, the program that implements the exemplary embodiment may of course be stored on a recording medium such as a CD-ROM and provided via the recording medium.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A transmit destination changing apparatus comprising:
an acquiring unit that acquires track record information, the track record information indicating a track record of printing of print data transmitted from a print data transmitting apparatus to a first printer among a plurality of printers, the track record information indicating a track record of printing performed on each of the plurality of printers in response to a print request; and
an output unit that outputs change instruction information if the track record information indicates that print data transmitted to the first printer from the print data transmitting apparatus is likely to be printed on a second printer among the plurality of printers in response to a print request, the change instruction information instructing that a destination of the print data be changed to cause the print data to be transmitted to the second printer from the print data transmitting apparatus.

2. The transmit destination changing apparatus according to claim 1,
wherein as the track record information, the acquiring unit acquires, for each of the plurality of printers, a number of times that the print data transmitted to the first printer is printed on the printer within a predetermined period of time in response to a print request, and
wherein the output unit outputs the change instruction information if the number of times acquired for each of the plurality of printers indicates that a greatest number of times is acquired for the second printer.

3. The transmit destination changing apparatus according to claim 1,
wherein as the track record information, the acquiring unit acquires, for each of the plurality of printers, a cumulative number of times that the print data transmitted to the first printer is printed on the printer in response to a print request, and
wherein the output unit outputs the change instruction information if the number of times acquired for each of the plurality of printers indicates that a greatest number of times is acquired for the second printer.

4. The transmit destination changing apparatus according to claim 1,
wherein as the track record information, the acquiring unit acquires, for each of the plurality of printers, a number of times that the print data transmitted to the first printer is printed on the printer in response to a print request, and a value indicative of timing at which the print data is printed, and
wherein the output unit outputs the change instruction information if the value acquired for each of the plurality of printers indicates that a greatest value is acquired for the second printer.

5. The transmit destination changing apparatus according to claim 1,
wherein as the track record information, the acquiring unit acquires, for each of the plurality of printers, a number of times that the print data transmitted to the first printer is printed on the printer for a specific print attribute in response to a print request, and
wherein the output unit outputs the change instruction information if the number of times acquired for each of the plurality of printers indicates that a greatest number of times is acquired for the second printer.

6. A printing system comprising:
a plurality of printers that each perform printing of print data in response to a print request; and
a transmit destination changing apparatus that changes, from among the plurality of printers, a printer to which the print data is transmitted from a print data transmitting apparatus, the transmit destination changing apparatus including
an acquiring unit that acquires track record information, the track record information indicating a track record of printing of print data transmitted from the print data transmitting apparatus to a first print among the plurality of printers, the track record information indicating a track record of printing performed on each of the plurality of printers in response to a print request, and
an output unit that outputs change instruction information if the track record information indicates that print data transmitted to the first printer from the print data transmitting apparatus is likely to be printed on a second printer among the plurality of printers in response to a print request, the change instruction information instructing that a destination of the print data be changed to cause the print data to be transmitted to the second printer from the print data transmitting apparatus.

7. A non-transitory computer readable medium storing a program causing a computer to execute a process, the process comprising:
acquiring track record information, the track record information indicating a track record of printing of print data transmitted from a print data transmitting apparatus to a first printer among a plurality of printers, the track record information indicating a track record of printing performed on each of the plurality of printers in response to a print request; and
outputting the change instruction information if the track record information indicates that print data transmitted to the first printer from the print data transmitting apparatus is likely to be printed on a second printer among the plurality of printers in response to a print request, the change instruction information instructing that a destination of the print data be changed to cause the print data to be transmitted to the second printer from the print data transmitting apparatus.
